(19) United States
(12) Patent Application Publication
(10) Pub. No.: US 2018/0144651 A1
(43) Pub. Date: May 24, 2018

(54) TEACHING METHOD USING PUPIL'S OWN LIKENESS AS A VIRTUAL TEACHER

(71) Applicant: MARDOCHE ABDELHAK, Lakewood, NJ (US)

(72) Inventor: MARDOCHE ABDELHAK, Lakewood, NJ (US)

(21) Appl. No.: 15/876,369

(22) Filed: Jan. 22, 2018

Related U.S. Application Data
(63) Continuation-in-part of application No. 15/183,476, filed on Jun. 15, 2016, now abandoned.
(60) Provisional application No. 62/191,971, filed on Jul. 13, 2015.

(51) Int. Cl. G09B 5/06; G09B 7/00; A63F 13/85; G06T 13/40; G10L 17/26; G06K 9/00

(52) U.S. Cl. CPC G09B 5/065; G09B 7/00; A63F 13/85; H04N 9/87; G10L 17/26; G06K 9/00261; G06T 13/40

(57) ABSTRACT

A teaching method is presented herein. The teaching method includes receiving a pupil likeness of a pupil and creating a virtual teacher avatar based on the pupil likeness. Furthermore a virtual environment having one or more students and the pupil likeness is provided. A teaching lesson for a benefit of the pupil, while being taught to the one or more students, by the virtual teacher avatar is presented; wherein the presenting the teaching lesson includes asking for pupil input.

### CROSS-REFERENCE TO RELATED APPLICATION

The present application is a continuation-in-part of U.S. patent application Ser. No. 15/183,476, filed Jun. 15, 2016, which claims the benefit of and priority to U.S. Provisional Patent Application No. 62/191,971, filed Jul. 13, 2015, the entire contents of which are hereby incorporated by reference herein.

### BACKGROUND OF THE INVENTION

The present invention is directed to a teaching system and, more particularly, to a teaching system comprising having the student pupil's likeness as a virtual teacher avatar and thereby enhance a student's interest in being involved with and carefully absorbing the teaching materials.

In the prior art, various systems have been described that utilize virtual teachers or teaching methods and this prior art is reflected at least in the U.S. Pat. Nos. 6,234,802; 6,290,571; 7,378,585; 7,846,049; 8,682,241; and 9,747,722. The entire contends of the above listed United States patents are incorporated by reference herein.

It is widely known and recognized that it is difficult to keep the attention of young pupils focused on lessons, particularly when the lesson subject matters might require concentration and would be deemed by many young students in the lower classes of elementary school to be “boring”. Many attempts have been made to arouse or keep the attention span of the very young students active throughout a lesson period by enticing them with side stories or surprises or the like. The present invention is focused on grabbing and maintaining the attention of the very young students through an innovative concept of having the lessons being delivered by one of the students.

### SUMMARY OF THE INVENTION

Accordingly, it is a general object of the present invention to provide a virtual teaching system and method that will more powerfully involve students and maintain their attention span throughout a lesson.

It is a further object of the invention to provide a virtual teaching system where greater student participation is promoted.

The foregoing and other objects of the invention are realized in accordance with the present invention by a virtual teaching system, in which the students or pupils themselves are involved in the teaching effort by having a pupil's likeness used as a virtual teacher avatar, delivering the lesson to one or more students that constitute the classroom. The virtual teacher avatar likeness can be changed from one lesson to the next or even during a lesson to keep the students entertained and thereby more interested in listening and following the lessons.

In accordance with preferred embodiments, the invention comprises a virtual teaching system, for creating a teaching lesson delivered by a student avatar, the teaching system including: a base lesson processing and creating module configured to create a base video file of a teacher delivering a lesson text, said base video file containing facial orientations, body movements and sounds produced by the teacher; a converter module for creating from the base video file an intermediate video file in which the teacher's facial orientations and movements are produced in an animated form and the teacher's sounds are synchronized to the intermediate video file; an interface module configured to receive photos of a pupil, in different facial orientations; and an avatar file creating module configured to receive the pupil's photos and to substitute in the intermediate video file the pupil's photos in matched relationship to the facial orientations in the intermediate video file, and to produce thereby an avatar video file in which the lesson text is delivered by an avatar having the likeness of said pupil. The teaching system may include a play back system for playing the avatar video file to group of pupils that includes said pupil.

In a preferred embodiment, the teaching system includes a module for receiving voice samples of the pupil, analyzing the voice samples and deriving therefrom pupil voice characteristics and modifying the teacher's sounds based on the pupil's voice characteristics to obtain an avatar voice that mimics the pupil's voice. It may further include a playback system including a display, for presenting the avatar-based teaching lesson to a class in which the pupil is present, on said display. It may further include a wireless interface system that is configured to enable mobile devices associates with the pupil and with other pupils located in the class to communicate with the teaching system while the teaching system is playing back a lesson and is further configured to enable the playing of the avatar video file to be halted, while pupil statements, questions or responses are played on said display of the system.

In a preferred embodiment, the teaching system comprises a multi-section display screen that enables simultaneous displaying of the avatar pupil alongside teaching materials. The teaching system also comprises a live camera configured to video and display one or more of the students on a camera display section of the screen. The avatar video file may include a section in which the pupil teaching avatar presents quiz questions to a student classroom body. The system may also display answers to the quiz questions in multiple-choice formats and pupils are able to respond to those questions using smartphones carried by the pupils. And the teaching system may be configured to produce cumulative response scores relative to pupil responses and to display those response scores on the screen. A microphone may be included to receive students' vocal responses and to play the vocal responses through a speaker of the system.

In a preferred embodiment, the teaching system includes a registration module configured to enable a plurality of lesson texts to be available for downloading by individual students and/or educators. The teaching system comprises a CPU and associated memories. And the system may include a module for pointing the camera at individual locations associated with different pupils in a classroom and correlating each said location with a smartphone carried by a pupil at each such location. The system may further include a billing system configured to enable member of the public to view clips of lessons, including abstracts of lesson, and to purchase specific lessons.

Other features and advantages of the present invention will become apparent from the following description of the invention which refers to the accompanying drawings.

### BRIEF DESCRIPTION OF THE DRAWING(S)

FIG. 1 is a perspective of a display screen of the system of the present invention showing various display sections that may be utilized to display different teaching material aspects.

FIG. 1a is a block diagram of hardware and software components of the system of the present invention.

FIG. 2 is a block diagram and flow chart of a process for creating the lesson contents.

FIG. 3 is a block diagram showing the flow steps for creating from a recorded video lesson presentation an avatar formatted teaching lesson.

FIG. 4 is a flowchart showing the interactive presentation of an avatar delivered teaching lesson.

### DETAILED DESCRIPTION OF EMBODIMENTS OF THE INVENTION

The present disclosure is illustrated by way of example. It should be noted that references to “an” or “one” embodiment in this disclosure are not necessarily to the same embodiment, and such references mean at least one.

A definition that applies throughout this disclosure will now be presented. The term “comprising” means “including, but not necessarily limited to”; it specifically indicates open-ended inclusion or membership in a so-described combination, group, series and the like.

Methods of teaching comprising having the student pupil's likeness as a virtual teacher avatar to one or more students are described herein. The teacher will be an avatar with at least one characteristic of the pupil. In some embodiments, an avatar of the teacher will be used in a virtual setting.

In some embodiments, the teacher avatar will be teaching a classroom of students. It is believed that this novel approach of having the pupil see himself or herself as the teacher and teaching the class will improve the learning of the pupil. In some embodiments, one or more of the students will be designed to resemble people and/or beings within the pupil's life (e.g. parent, sibling, and friend).

In some embodiments, the virtual teacher avatar will be teaching an individual student. In some embodiments, the student can also have one or more characteristics that are assigned by the pupil. The student can be an avatar designed by the pupil. In some embodiments, the student is an animal. In some embodiments, the animal is made to have an appearance that is similar to the pupil's own animal. In some embodiments, the student is an avatar of the pupil's pet (e.g. dog and cat). Having the students with characteristics of beings personally known to the pupil will help establish an emotional investment in the students and their wellbeing.

The teaching method provides that the pupils will learn better by watching themselves teach the subject matter. They may establish a sense of responsibility for the students that are teaching and instill confidence in the pupil. Instead of being lectured, the pupil is watching themselves lecture. By having the students view them with respect for the knowledge they are imparting, it establishes confidence in their abilities as they see themselves as the one in charge. They will view themselves as the one with the knowledge and the self-confidence to teach. This would be very helpful for children who may come from families without much education, where confidence of one's ability might be more lacking.

In some embodiments, the program will provide for proof of lessons for the students. This can be done after a teaching session or as a review of lessons. The students may ask a question of their teacher, the pupil, during the proof of lesson. If the teacher does not provide the proper answers, some negative consequence could ensue for the students. An example of a teaching and subsequent proof of lesson can include a water/pool safety lesson such that a wrong answer will result in some sort of perilous harm for the student. The student can then respond to the pupil with, negative or positive, and emotion and/or statements to help emphasize the importance of the lesson. Given that the teacher has an appearance similar to the pupil, the responsibility of the lesson will greater impact on the pupil, resulting it a better teaching for the pupil. In the embodiments where the one or more students resemble people and/or pets in the pupil's actual life, the personal attachment will be more real to the pupil and have a more lasting teaching effect on the pupil.

In some embodiments, a game scenario will be presented to the pupil where they are instructing the teacher avatar and/or one or more students in some activity. Points will accumulate and/or deduct based on input by the pupil. In some embodiments, when the pupil reaches predetermined amount of points, the pupil will advance to a new level. The number of levels is not limited.

In some embodiments, a test will be provided to the pupil, after the completion of one or more lessons, to test the progress of the pupil. In some embodiments, the test will determine if the pupil advances to a new lesson. Some tests will serve as a review. In some embodiments, progress of the pupil will be tracked and/or reports produced to indicate the progress, strengths and/or weaknesses of the pupil.

In some embodiments the pupil, as the teacher, will have to make the decisions and/or teachings before the proof of lesson is performed. Then the students, guided by the decisions, will enter a proof of lesson test and perform as instructed by the pupil. This will help the pupil learn foresight.

In some embodiments the making of the virtual teacher avatar, requires one or more pictures of the pupil to be uploaded and a virtual teacher avatar will incorporate one or more of the aspects of the photo. The conversion from photo to avatar can be done by a computer program, the pupil, an individual at the host company, or any combination thereof In some embodiments, if the pupil has a previously made avatar from some avatar creating site, the avatar can be uploaded. In some embodiments, the avatar will incorporate the actual picture into the face of the avatar. I some embodiments, a three dimensional face will be derived from the picture and act as the avatar's face. It is also understood that all the means for creating the teacher avatar can also be used to make the one or more student avatars.

The virtual class, game scenario, proof of lesson and/or test, where some of the interactions may be shown, can be provided by a program hosted on the pupil's computer, station, gaming console, a remote server or any combinations thereof. The virtual class will provide the interface for the pupil to use the teacher to instruct the one or more students and view and/or participate in the proof of lessons. The virtual class will instill desire in the pupil to learn and the confidence that they will achieve.

An embodiment of the teaching method is provided by way of example, as there are a variety of ways to carry out the method. The method described below can be carried out using the configurations explaining example method. Each step represents one or more processes, methods or subroutines, carried out in the embodiments of the teaching. Furthermore, any labeling of the steps that may indicate an order are only present for identification purposes and they, in and of themselves, are not an indication of the order steps, as the steps can change according to the present disclosure and/or claims. Additional steps can be added or fewer steps may be utilized, without departing from this disclosure. As an example, one embodiment can begin at step S1, while another can begin at step S2. An embodiment of a teaching method comprises the following:

(s1) receiving a pupil likeness;

(s2) creating a virtual teacher avatar based on the pupil likeness;

(s3) providing a virtual environment comprising one or more students and the virtual teacher avatar; and

(s4) presenting a teaching lesson for the benefit of the pupil while being taught to the one or more students by the virtual teacher avatar; wherein the presenting teaching lessons comprises asking for pupil input.

Some embodiments of the teaching method will further comprise one or more of the following:

(s5) the pupil likeness comprises one or more electronic files containing one or more pupil photos;

(s6) the one or more pupil photos comprises the pupil's face; and the creating the virtual avatar comprises creating a teacher avatar face; wherein the creating the teacher avatar face comprises obtaining the pupil's face from the one or more pupil photos, and applying a photo likeness of the pupil's face to the teacher avatar face;

(s7) the virtual environment comprises a virtual classroom;

(s8) the virtual environment comprises a game scenario;

(s9) receiving one or more student photo files of the one or more students; and deriving a student likeness for the one or more students from the one or more student photo files that correspond to each of the one or more students; wherein the one or more students comprises beings personally known to the individual;

(s8) the one or more students comprises a pupil parent;

(s9) wherein the one or more students comprises an animal;

(s10) providing a proof of lesson, wherein the proof of lesson comprises a scenario where a previous teaching is applied;

(s11) the proof of lesson further comprises a negative consequence for the one or more students when the pupil input is not correct, and the one or more students will present a negative emotion, statement, or both a negative emotion and statement towards the virtual teacher avatar; and/or

(s12) receiving one or more student photo files of the one or more students; and deriving a student likeness for the one or more students from the one or more student photo files that correspond to each of the one or more students; wherein the one or more students comprises beings personally known to the individual.

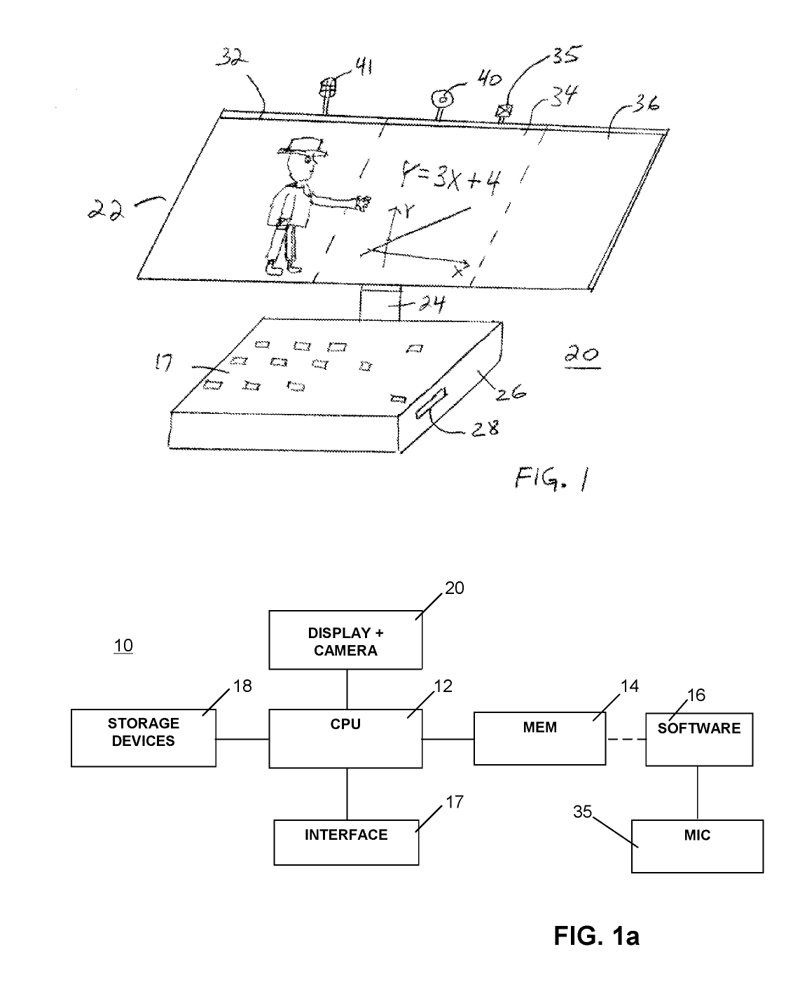

The foregoing and other aspects of the invention can be more readily absorbed and appreciated by reference to the description below of embodiments of the invention which refers to the drawings. Turning first to FIG. 1 and to FIG. 1a, the present invention utilizes a system 10 that comprises a computer or server processor with a CPU 12 which is coupled to writable memory 14, storage memory and like devices 18 and an interface 17 that can receive various user or operator instructions in order to display or play a lesson lecture or plan on a display 20. The system 10 may also include a camera 40 mounted on or adjacent to the display 20. The system 10 executes various algorithms that are defined by software 16, which software 16 may also be coupled to a microphone 35 for purposes of implementing voice recognition commands or for playing voice files to a student body.

Focusing more closely on the pupil lesson delivered through a display system 20, it can be seen that the display system may include a screen 22, which optionally can be supported on a stand 24 that is coupled to the computer hardware 26 which may have a slot 28 for receiving content media as well as the interface 17, in a form of a familiar computer keyboard. The display screen 22 may be divided into several sections including a teaching avatar section 32, a teaching material display section 34 and a video playing section 36, which may receive input from a camera 40 that scans or focuses on several or individual students and displays their likeness to the entire classroom, and optimally their vocal responses through a speaker 41, to further pique the interest of the students to follow the lesson.

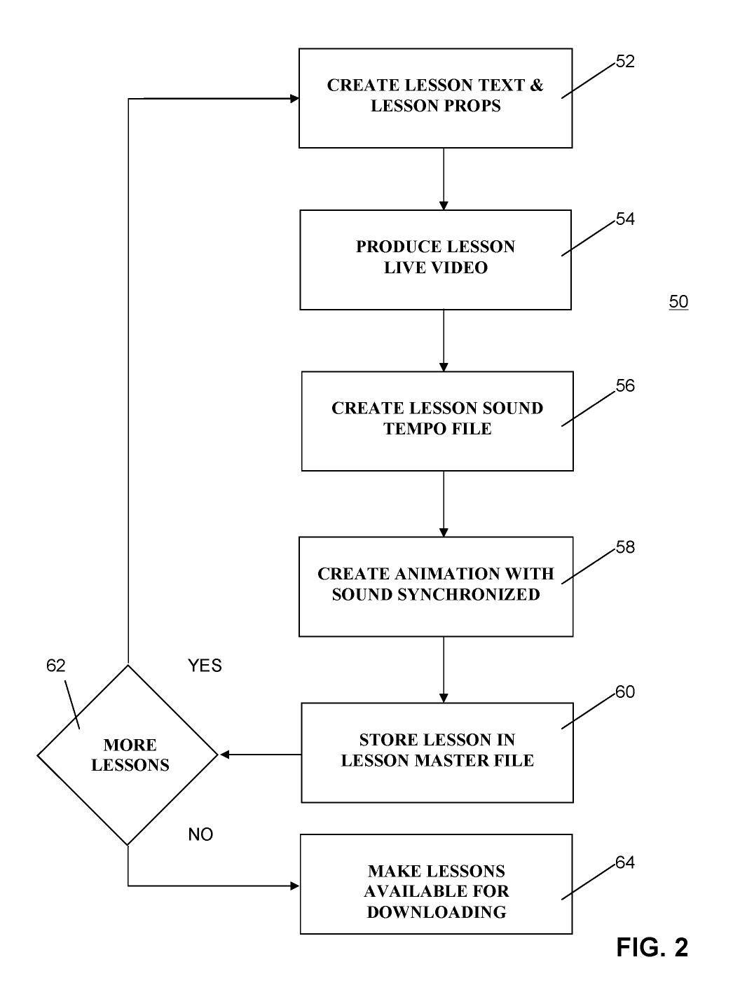

With reference to FIG. 2, in a preferred embodiment, the module 52 represents the steps involved in first creating a lesson by writing out the speaking text for the lesson and also creating the various lesson aides, for example quotations from a text or photographic material with various highlights. Once the basic lesson text and various prompts or props or the like have been created, the module 54, which is part of the lesson creation sub-system 50 is responsible for having a real-life teacher act out and deliver the video-recorded lesson, which can then be viewed, edited and finally approved to enable it to be utilized by the next system lesson creation module 56, which studies the voice file of the teacher's sound or voice content and creates a digital representation thereof, effectively a definition file of the length of individual words, the volume (loudness) of the words and the overall tempo of the voice file. The animation module 58 then takes the video content and creates an animation-equivalent of the teacher's performance, showing the teacher's dynamic facial orientation, dynamic hand positions and body movements. This results in an animation version of that video content and that animated video content is then synchronized with the sound file that has been created by the module 56. At this point, lesson content is available that can now be utilized for the most important purpose, which is to substitute for the animated lesson teacher an avatar version thereof, which will be one of the students in the classroom who will be listening and observing that lesson by himself.

The thus created initial lesson is stored in a master library file with various other, similarly created lessons accompanied by short descriptions or abstracts to enable selection from among many different lessons. This process can be repeated as indicated by decisional block 62 to create additional lessons and when the overall process is completed, the module 64 is responsible for making the various lessons and their short abstracts available for downloading by individual educators, teachers or the like or even privately for home viewing.

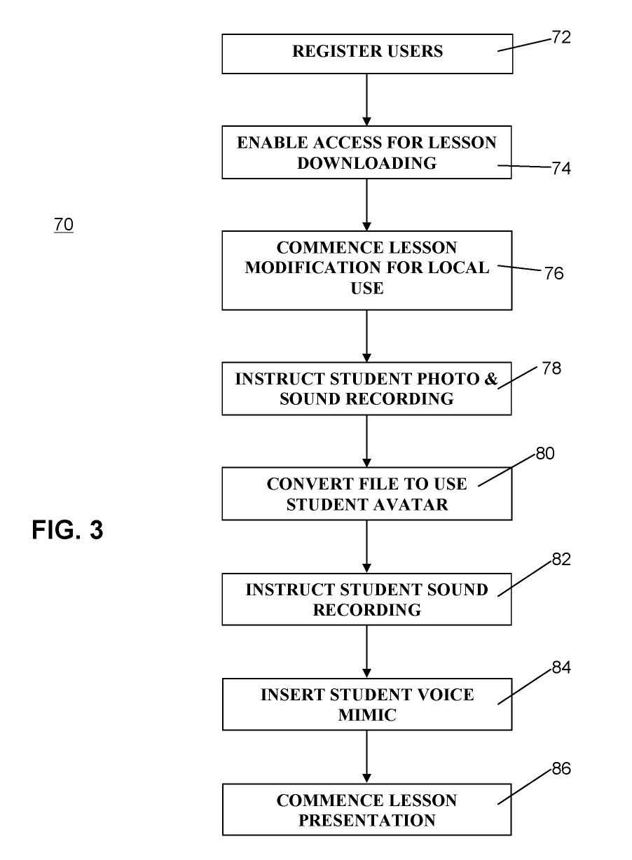

Referring to FIG. 3, to create the avatar-based lesson, the avatar creation subsystem 70 comprises a registration module 72 for initially registering users and attending to various fee payments and the like that are required for usage of the system. Once registration steps have been completed, the access module 74 allows the actual lesson plans and presentations to be downloaded to the account of a specific user, using the customers' own computer systems. Once the downloading is completed, the actual process of substituting a student avatar commences at a the module 76 which directs the person responsible for educating the pupils to commence playing a step-by-step instruction sequence at the instruction module 78 asking that a student stand in front of the camera 35 to enable the student's head portion and body to be photographed from various angles, in a manner that provides the various angles, positions, body inclinations and movements of the animated teacher previously prepared. The avatar insertion modification module 80 then substitutes for the video content of the lesson, the pupil's likeness and body including clothing and various positions and converts the entire lesson plan so that the teacher/avatar delivering the lesson is none other than one of the students who will be listening to the specific lesson.

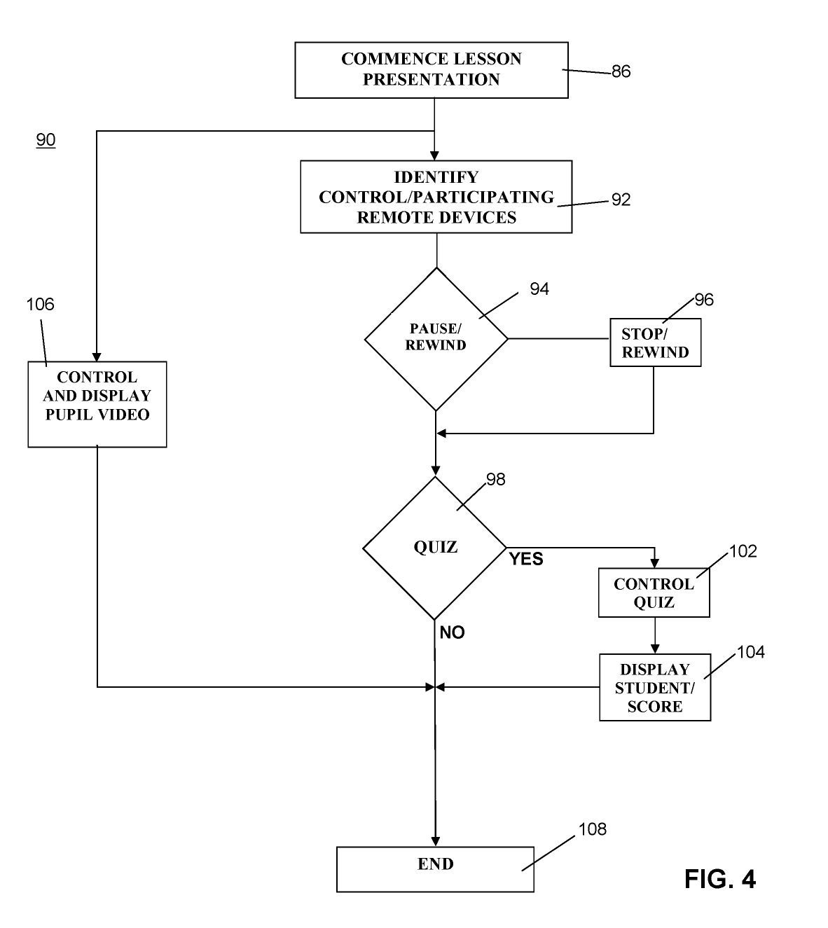

The voice conversion module 82 performs the same function as the module 80 but the conversion involved here is to ask the student to recite various, specified sentences or specific words and then the software analyzes the student's sound for base content, loudness, pitch and other phonetical parameters and substitutes a voice or a sound that mimics the student's voice into the program lesson. This step is completed in the module 86 at which point the overall avatar creation subsystem 70 directs the user to the lecture delivery subsystem 86, which is more fully described by reference to FIG. 4.

In the lesson delivery subsystem 90 of FIG. 4, when activated, a lesson commences by the control provided by the presentation module 86. The module 92 is an overall control and participation module that can also initially identify and associate with the system 10 various remote controls, for example smartphone devices, that could interact with the system and which may be carried by individual pupils that allows them to respond to questions as described further on, enabling quiz question participation or to become interactively involved with the delivery of the lesson. The decisional module 94 can “listen” to one of the controlling devices which could be one of the designated smartphones and when a stop command is recognized, the module 96 stops the program to allow discussions with a local proctor or teacher or for the purpose of enabling rewinding of the lesson, partially or fully, if students have raised their hand that they did not understand a particular section.

Normally, the lesson can be played without interruption from beginning to end. However, in accordance with the present invention, as part of the lesson, quizzes can be played (at the lesson end, or intermittently) which will become activated by the decisional module 98 in response to receiving a “yes” response at which point the avatar teacher might either have specific questions displayed on the screen and allow students to, for example, choose one of four multi-choice answers that are displayed by pressing for example the letters “a” or “b” or “c” or “d” on their smartphones. The modules 102 and 104 enable the students' cumulative test scores of various students to be displayed in the display section 34 of the screen 22. Even greater control might be afforded by having the subsystem 106 control and display students speaking up and responding to questions and while they do so, the camera 40 would note the location of the student because the location of each student's smartphone and that location is preprogramed into the system and the student currently speaking can be shown on the screen display section 36.

The embodiments shown and described above are only examples. Many details are often found in the art such as the other features for producing a progress report. Therefore, many such details are neither shown nor described. Even though numerous characteristics and advantages of the present technology have been set forth in the foregoing description, together with details of the structure and function of the present disclosure, the disclosure is illustrative only, and changes may be made in the detail and arrangement of the steps within the principles of the present disclosure up to, and including the full extent established by the broad general meaning of the terms used in the claims. It will therefore be appreciated that the embodiments described above may be modified within the scope of the claims.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A virtual teaching system, for creating a teaching lesson delivered by a student avatar, the teaching system comprising:
a base lesson processing and creating module configured to create a base video file of a teacher delivering a lesson text, said base video file containing facial orientations, body movements and sounds produced by the teacher;
a converter module for creating from the base video file an intermediate video file in which the teacher's facial orientations and movements are produced in an animated form and the teacher's sounds are synchronized to the intermediate video file;
an interface module configured to receive photos of a pupil, in different facial orientations; and
an avatar file creating module configured to receive the pupil's photos and to substitute in the intermediate video file the pupil's photos in matched relationship to the facial orientations in the intermediate video file, and to produce thereby an avatar video file in which the lesson text is delivered by an avatar having the likeness of said pupil.

2. The teaching system of claim 1, including a play back system for playing the avatar video file to group of pupils that includes said pupil.

3. The teaching system of claim 1, further including a module for receiving voice samples of the pupil, analyzing the voice samples and deriving therefrom pupil voice characteristics and modifying the teacher's sounds based on the pupil's voice characteristics to obtain an avatar voice that mimics the pupil's voice.

4. The teaching system of claim 3, further including a playback system including a display, for presenting the avatar-based teaching lesson to a class in which the pupil is present, on said display.

5. The teaching system of claim 4, including a wireless interface system that is configured to enable mobile devices associates with the pupil and with other pupils located in the class to communicate with the teaching system while the teaching system is playing back a lesson and is further configured to enable the playing of the avatar video file to be halted, while pupil statements, questions or responses are played on said display of the system.

6. The teaching system of claim 1, wherein the system comprises a multi-section display screen that enables simultaneous displaying of the avatar pupil alongside teaching materials.

7. The teaching system of claim 6, wherein the teaching system comprises a live camera configured to video and display one or more of the students on a camera display section of the screen.

8. The teaching system of claim 1, wherein the avatar video file includes a section in which the pupil teaching avatar presents quiz questions to a student classroom body.

9. The teaching system of claim 8, wherein the system also displays answers to the quiz questions in multiple-choice formats and pupils are able to respond to those questions using smartphones carried by the pupils.

10. The teaching system of claim 9, wherein the teaching system is configured to produce cumulative response scores relative to pupil responses and to display those response scores on the screen.

11. The teaching system of claim 10, further including a microphone for receiving students' vocal responses and to play the vocal responses through a speaker of the system.

12. The teaching system of claim 1, including a registration module configured to enable a plurality of lesson texts to be available for downloading by individual students and/or educators.

13. The teaching system of claim 1, in which the teaching system comprises a CPU and associated memories.

14. The teaching system of claim 7, including a module for pointing the camera at individual locations associated with different pupils in a classroom and correlating each said location with a smartphone carried by a pupil at each such location.

15. The teaching system of claim 12, including a billing system configured to enable member of the public to view clips of lessons, including abstracts of lesson, and to purchase specific lessons.
